(19) United States
(12) Patent Application Publication
(10) Pub. No.: US 2015/0089439 A1
(43) Pub. Date: Mar. 26, 2015

(54) ELECTRONIC DEVICE, METHOD FOR CONTROLLING THE SAME, AND CONTROL PROGRAM

(71) Applicant: ARKRAY, INC., Kyoto (JP)

(72) Inventor: Atsushi WADA, Kyoto-shi (JP)

(73) Assignee: ARKRAY, INC., Kyoto (JP)

(21) Appl. No.: 14/492,247

(22) Filed: Sep. 22, 2014

(30) Foreign Application Priority Data
Sep. 25, 2013 (JP) 2013-198307
Sep. 11, 2014 (JP) 2014-185267

(51) Int. Cl. G06F 3/0485; G06F 3/0481; G06F 3/0488; G06F 3/0484

(52) U.S. Cl. CPC G06F 3/0485; G06F 3/04845; G06F 3/0481; G06F 3/0488
USPC 715/784

(57) ABSTRACT

During execution of software, additional information can be displayed in such a manner that the additional information attracts a user's attention while being unlikely to bother the user. An electronic device includes a display panel, the display panel having a display screen and a detection unit that detects a position on the display screen that is designated with a finger or a pointing tool, and a control unit that executes software involving an output of an image to the display panel. On detecting a sliding motion of a user's finger or a pointing tool on the display panel on which the image is displayed, the control unit executes processing that is necessary in order to realize the function of the software, and in accordance with the sliding motion of the finger or the pointing tool, displays the image while sliding the image and displays additional information.

### CROSS REFERENCE TO RELATED APPLICATIONS

This application claims benefit of priority to Japanese Patent Application No. 2013-198307 filed Sep. 25, 2013, and to Japanese Patent Application No. 2014-185267 filed Sep. 11, 2014, the entire content of each of which is incorporated herein by reference.

### TECHNICAL FIELD

The disclosure of the present application relates to a technology for controlling display processing that is executed by software in accordance with a user operation through a display panel of an electronic device.

### BACKGROUND

Electronic devices equipped with touch panels, such as smartphones, tablet terminals, etc., have recently been becoming more widespread. In such electronic devices, various contrivances are employed in order to improve the ease of user operation of the touch panels with limited display screen sizes (see JP 2011-176459A, JP 4777121B, JP 2013-20420A, and JP 2004-152217A, for example).

Also, software, such as various applications (programs), an operating system, and the like, may be executed on electronic devices. For example, on a touch panel of an electronic device during execution of an application, in addition to information for realizing a function of that application, information, such as advertising information, that is not directly related to the function of that application may also be displayed. JP 2010-186350A, for example, discloses an electronic terminal in which moving image data in which an advertising image is embedded in a main image is displayed on a main panel, and an advertising key is displayed on a key panel.

### SUMMARY

In an electronic device, during execution of software for realizing a particular function to be used by a user, if additional information that is not directly related to the function to be realized is displayed, the space for displaying information for realizing the function of that software is reduced by an amount corresponding to that additional information. Such additional information can be very annoying for the user who is using the function of the software. To avoid this situation, the size of the additional information can be reduced, or the display duration of the additional information can be reduced, but then the user is unlikely to notice the additional information.

Thus, the present application discloses an electronic device that enables display of additional information during execution of software for realizing a particular function in such a manner that the additional information attracts a user's attention while being unlikely to bother the user, a method for controlling the electronic device, and a control program.

An electronic device according to an embodiment of the preset disclosure includes a display panel having a display screen and a detection unit that detects a position on the display screen that is designated with a finger or a pointing tool, and a control unit that executes software for realizing a particular function involving an output of an image to the display panel. On detecting a sliding motion of a user's finger or a pointing tool on the display panel on which the image is displayed, the control unit executes processing that is necessary in order to realize the function of the software, and in accordance with the sliding motion of the finger or the pointing tool, displays the image while sliding the image and furthermore displays additional information in a space that is formed by the sliding of the image.

According to the disclosure of the present application, in an electronic device, additional information can be displayed during execution of software for realizing a particular function in such a manner that the additional information attracts a user's attention while being unlikely to bother the user.

### BRIEF DESCRIPTION OF THE DRAWINGS

FIG. 1 is a functional block diagram showing an example of the configuration of an electronic device according to an embodiment.

FIG. 2 is a flowchart illustrating an example of the operation of an electronic device 10.

FIGS. 3A, 3B, and 3C are diagrams showing an example of a screen transition in the case where an image is displayed in a sliding manner.

FIGS. 4A, 4B, and 4C are diagrams showing another example of a screen transition in the case where an image is displayed in a sliding manner.

FIG. 5 is a flowchart illustrating an example of processing for performing control so that an image is returned to its original position after a sliding motion is ended.

FIG. 6 is a flowchart illustrating an example of processing for executing additional processing in the case where a sliding motion is performed for more than a certain duration or distance.

FIG. 7 is a flowchart illustrating an example of processing for controlling, in accordance with the velocity of a sliding motion of the user, additional information to be displayed.

FIG. 8 is a flowchart illustrating an example of processing for specifying and displaying additional information.

FIG. 9 is a flowchart illustrating an example of processing for controlling additional information based on a relationship between a sliding motion of the user and the timing at which a space is formed.

FIG. 10A is a diagram for explaining an example in the case where a sliding motion of the user has already been ended when a space is generated.

FIG. 10B is a diagram for explaining an example in the case where a sliding motion of the user has not yet been ended when a space is generated.

FIG. 11 is a flowchart illustrating a variation of judgment processing in steps S905 and S906 of FIG. 9.

### DETAILED DESCRIPTION

An electronic device according to an embodiment of the present disclosure includes a display panel having a display screen and a detection unit that detects a position on the display screen that is designated with a finger or a pointing tool, and a control unit that executes software involving an output of an image to the display panel. On detecting a sliding motion of a user's finger or a pointing tool on the display panel on which the image is displayed, the control unit executes processing that is necessary in order to realize the function of the software, and in accordance with the sliding motion of the finger or the pointing tool, displays the image while sliding the image and furthermore displays additional information in a space that is formed by the sliding of the image.

With this configuration, when the user performs a motion for sliding an image that is displayed during execution of the software with a finger or a pointing tool, the image is displayed in a sliding manner in accordance with that sliding motion, and in a space that is thus formed, the additional information is displayed. In this manner, the additional information is displayed in a space that is formed by the sliding of the image, and therefore the additional information is unlikely to interfere with the user's use of the software. Moreover, the additional information emerges in accordance with the motion of the user, and is therefore likely to attract the user's attention. Furthermore, processing that is necessary in order to realize the function of the software is executed by the sliding motion of the user, and therefore the additional information is displayed when the user performs a necessary operation of the software. Thus, it is extremely likely that the additional information comes to the user's notice. As a result, it is possible to display the additional information during execution of the software in such a manner that the additional information attracts the user's attention while being unlikely to bother the user.

The contents of the additional information are not particularly limited, and the additional information can be, for example, information that is not directly related to the function to be realized by the software. For example, an advertisement, a weather forecast, exchange rate information, time information, fortune-telling information, or other information etc. that can be used by the software can be used as the additional information. In this manner, information that is not directly related to the function to be realized by an image currently being displayed on the electronic device is used as the additional information, and it is therefore possible to effectively present information to the user that the user may possibly be interested in while preventing that information from interfering with the realization of the function of the software.

It is possible that if an amount of physical or temporal change in the sliding motion of the user's finger or the pointing tool exceeds a threshold value, the control unit further executes additional processing.

In this manner, execution of the additional processing is controlled based on the amount of change in the sliding motion, and it is therefore possible for the user to cause the additional processing to be executed by continuing the sliding motion so as to increase the amount of physical or temporal change in the sliding motion. The amount of physical or temporal change in the sliding motion of the user's finger or the pointing tool may be, for example, the distance or duration of the sliding motion. Here, the additional processing may be processing related to the additional information. For example, processing for accessing information related to the additional information, processing for providing a function related to the additional information, or the like can be executed as the additional processing. In this case, for example, if the user is interested in the additional information that the user glimpsed when performing a sliding operation, if the user continues the sliding operation even further, the user can receive information or a function related to the additional information.

It is possible that the control unit executes locking or unlocking of the electronic device, updating of information indicated by the image, or external data communication of the electronic device as the processing that is necessary in order to realize the function of the software.

Thus, a configuration is possible in which during execution of the software for realizing a particular function, such as locking or unlocking, updating of information indicated by the image, or external data communication, by the electronic device, processing that is essential or that is performed frequently is executed as a result of the sliding motion. Consequently, during execution of the software, the user is more likely to perform a sliding motion. Accordingly, the additional information is more likely to catch the user's notice.

It is possible that the control unit controls the additional information to be displayed in the space in accordance with a velocity of the sliding motion of the finger or the pointing tool.

A subtle difference in the sliding motion of the user can be reflected in the additional information by controlling the additional information in accordance with the sliding velocity.

It is possible that the control unit determines a relationship between a timing of the sliding motion of the finger or the pointing tool and a timing at which the space is formed by displaying the image while sliding the image in accordance with the sliding motion, and controls the additional information to be displayed in the space based on the determination.

Thus, based on the timings of the sliding motion of the user and the display of the image in a sliding manner, a subtle difference in the motion of the user can be distinguished and reflected in the additional information control processing.

It is possible that the control unit randomly selects the additional information to be displayed in the space from a plurality of items of previously stored information. Thus, the additional information to be displayed can be diversified.

It is possible that the control unit selects the additional information to be displayed in the space from a plurality of items of previously stored information based on a previously stored probability. This makes it possible to control the display frequency of a plurality of patterns of the additional information while displaying the plurality of patterns of the additional information.

It is possible that the control unit specifies, based on a previously stored charge for displaying the additional information, at least one of a display duration and a display order of the additional information to be displayed in the space. Thus, at least one of the display duration and the display order of the additional information can be appropriately specified in accordance with the charges for displaying the additional information, and display in the space can be performed accordingly.

It is possible that the control unit specifies the additional information to be displayed in the space in accordance with an external device that is connected to the electronic device. Thus, an external device connected to the electronic device can be reflected in the additional information.

It is possible that the control unit specifies the additional information to be displayed in the space each time the space is formed, and at a time point when the space is formed or at any time point during a period from said time point to when the additional information is displayed in the space, the control unit determines whether or not the sliding motion of the user's finger or the pointing tool has already been ended, and if the sliding motion has not yet been ended, the control unit displays information that is the same as the additional information that was displayed the previous time.

It is possible to display the additional information so as to conform to the user's intention by judging whether or not the sliding motion of the user has been ended at the time point when a space is formed. For example, if the sliding motion of the user has not yet been ended at the time point when the space is formed, it is highly likely that the user intends to view the additional information that was displayed the previous time, and thus it is possible to meet the user's intention by displaying, for example, the same information as the additional information that was displayed the previous time. Thus, it is possible to automatically discriminate between whether the space is formed merely due to inertia of the sliding motion or the user is intentionally wishing to view the additional information.

A method for controlling an electronic device including a display panel having a display screen and a detection unit that detects a position on the display screen that is designated with a finger or a pointing tool includes a step of a computer provided in the electronic device executing software for realizing a particular function involving an output of an image to the display panel, a step of the computer executing processing that is necessary in order to realize the function of the software on detection of a sliding motion of a user's finger or a pointing tool on the display panel on which the image is displayed, a step of displaying the image while sliding the image in accordance with the detected sliding motion of the finger or the pointing tool, and a step of displaying additional information in a space that is formed by the sliding of the image.

A program for controlling an electronic device including a display panel having a display screen and a detection unit that detects a position on the display screen that is designated with a finger or a pointing tool causes a computer to execute processing for executing software for realizing a particular function involving an output of an image to the display panel, processing for executing processing that is necessary in order to realize the function of the software on detection of a sliding motion of a user's finger or a pointing tool on the display panel on which the image is displayed, processing for displaying the image while sliding the image in accordance with the detected sliding motion of the finger or the pointing tool, and processing for displaying additional information in a space that is formed by the sliding of the image. Moreover, a non-transitory storage medium that stores this program is also included in embodiments of the present disclosure.

An electronic device according to an embodiment of the present disclosure includes a display panel having a display screen and a detection unit that detects a position on the display screen that is designated with a finger or a pointing tool, at least one processor, a memory, and at least one program. The program is configured to be stored in the memory and executed by the at least one processor. The program includes an instruction for executing software for realizing a particular function involving an output of an image to the display panel, an instruction for detecting a sliding motion of a user's finger or a pointing tool on the display panel on which the image is displayed, an instruction for executing processing that is necessary in order to realize the function of the software on detection of the sliding motion, an instruction for displaying the image while sliding the image in accordance with the sliding motion of the finger or the pointing tool, and an instruction for displaying additional information in a space that is formed by the sliding of the image.

Note that the above-described instruction group realizes the overall function of the above-described components, and it is not necessarily required that a predetermined function is realized by a single instruction. Also, provision of an instruction for executing particular processing that is designed with respect to each component is not necessarily required.

### Embodiments

### Example of Configuration of Electronic Device

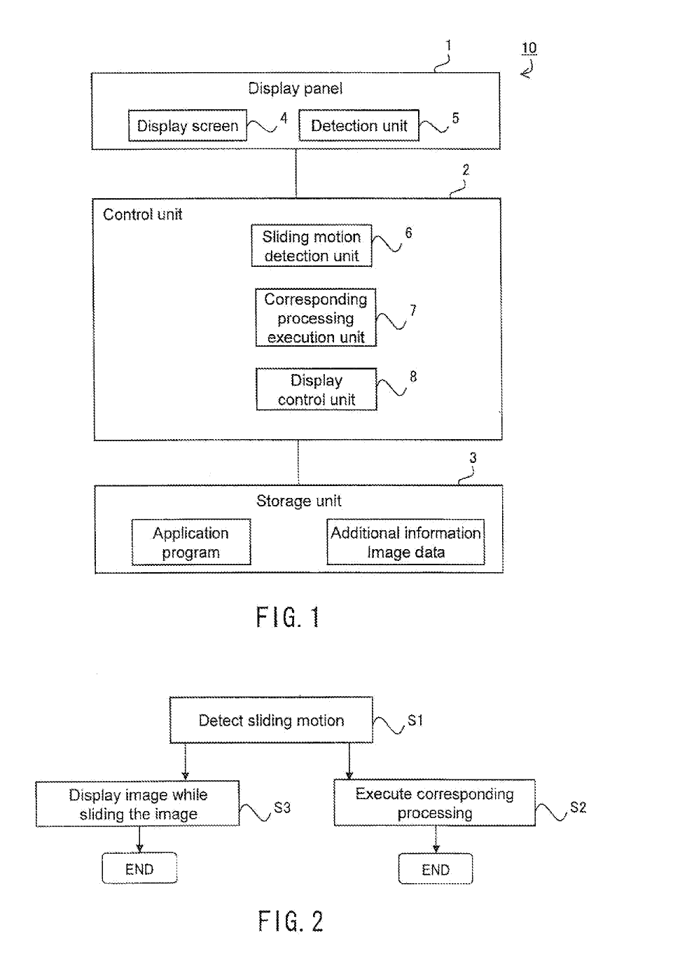

FIG. 1 is a functional block diagram showing an example of the configuration of an electronic device according to an embodiment. In the example shown in FIG. 1, an electronic device 10 includes a display panel 1, a control unit 2, and a storage unit 3. The display panel 1 has a display screen 4 and a detection unit 5 that detects a position on the display screen 4 that is designated with a finger or a pointing tool. The detection unit 5 detects the position on the display screen 4 that is indicated by the finger or the pointing tool and outputs a signal indicating that position to the control unit 2. Thus, the control unit 2 can acquire information on the indicated position on the display screen 4, which is indicated by the user with the user's finger or the pointing tool. The pointing tool may be, for example, a stylus or the like.

The control unit 2 can read and execute a program stored in the storage unit 3. An example of the program to be executed by the control unit 2 is software for realizing a function to be used by the user. In this embodiment, a case where a piece of software for realizing a particular function that can be used by the user through the display panel is executed will be described. The software that is executed here may be, for example, application software or system software (OS etc.), or a combination thereof. Such software may execute processing including, for example, output of an image to the display screen 4 of the display panel 1 and processing based on the indicated position indicated by the user that is detected by the detection unit 5 of the display panel 1. Hereinafter, a case where an application, which is an example of the software, for realizing a particular function is executed will be described. Although the particular function that is realized by the software can be any function, blood sugar level measurement, unlocking, and the like will be introduced as examples below.

In this embodiment, the control unit 2 has a sliding motion detection unit 6, a corresponding processing execution unit 7, and a display control unit 8. The sliding motion detection unit 6 detects a sliding motion of a finger of the user or a pointing tool on the display panel 1 on which an image of the application that is currently being executed is displayed. For example, the sliding motion detection unit 6 monitors the indicated position indicated by the finger of the user or the pointing tool that is detected by the detection unit 5 and can judge that a sliding motion is performed if the finger of the user or the pointing tool moves, in a particular region of a particular screen that is displayed by the application, for a certain distance or a certain duration while keeping the state of indicating the display screen.

The corresponding processing execution unit 7 executes, on detection of the sliding motion, processing that is necessary in order to realize the function of the application that is currently being executed. For example, it is possible to predetermine an image to be displayed by the application and processing to be executed if a sliding motion is performed in a particular region of that image and store the predetermined image and processing as a program of the application in advance. Thus, the corresponding processing execution unit 7 can execute predetermined processing on detection of a sliding motion in a particular region of a particular image.

When a sliding motion is detected, the display control unit 8 displays an image while sliding the image in accordance with that sliding motion, and furthermore displays additional information in a space that is formed by the sliding of that image. For example, if a single image is displayed within a given display frame (display region), and a sliding motion of the user with respect to this image is detected, the display control unit 8 displays this image while sliding this image within the display frame in the same direction as the sliding motion for a distance corresponding to the distance of the sliding motion. When an edge of the image moves within the display frame to the inside of one of the sides of the display frame as a result of the sliding of the image, a space (blank) is formed between the relevant side of the display frame and the edge of the image that has moved inward. The display control unit 8 displays additional information in a portion of this space. The additional information can be stored in the storage unit 3 in advance. For example, information that is stored as image (including moving image and still image) data, text data, data on links to images, and the like can be used as this additional information. Note that the data format of the additional information is not limited to a particular format.

The electronic device 10 shown in FIG. 1 may be, for example, a smartphone, a game console, an electronic book, a tablet terminal, a handheld blood sugar meter, or the like, but is not limited to a particular form. In this embodiment, a case where the electronic device 10 is applied to a smartphone, which is an example of a handheld device, will be described by way of example.

The display panel 1 can be configured by, for example, a touch panel such as a liquid crystal panel provided with a touch sensor. The control unit 2 can be configured by a computer provided in the electronic device 10. For example, functional units of the control unit 2 including the sliding motion detection unit 6, the corresponding processing execution unit 7, and the display control unit 8 can be realized by a processor executing a predetermined program. A program for causing a computer to function as the sliding motion detection unit 6, the corresponding processing execution unit 7, and the display control unit 8 and a non-transitory storage medium storing this program are also included in embodiments of the present disclosure. The storage unit 3 may be a storage such as a semiconductor memory built into the electronic device 10, or may be an external storage that can be accessed by the electronic device 10.

FIG. 2 is a flowchart illustrating an example of the operation of the electronic device 10. FIG. 2 illustrates the example of the operation in the case where a sliding motion of the user is detected by the control unit 2 while a given application is executed.

When a predetermined image is displayed by the application that is currently being executed, the sliding motion detection unit 6 detects a sliding motion of a finger of the user or a pointing tool on the display screen in a particular direction within a particular region of that image (step S1). If the sliding motion is detected, the corresponding processing execution unit 7 executes processing that is triggered by this sliding motion (step S2). At the same time, the display control unit 8 executes processing for sliding the image in accordance with the sliding motion (step S3). In step S3, additional information is displayed in a space that is formed by the sliding of the image.

Note that in the example illustrated in FIG. 2, the processing of the application that is triggered by the sliding motion (step S2) and the processing for sliding the image (step S3) are executed independently in different processes, but these two kinds of processing may also be executed in the same process.

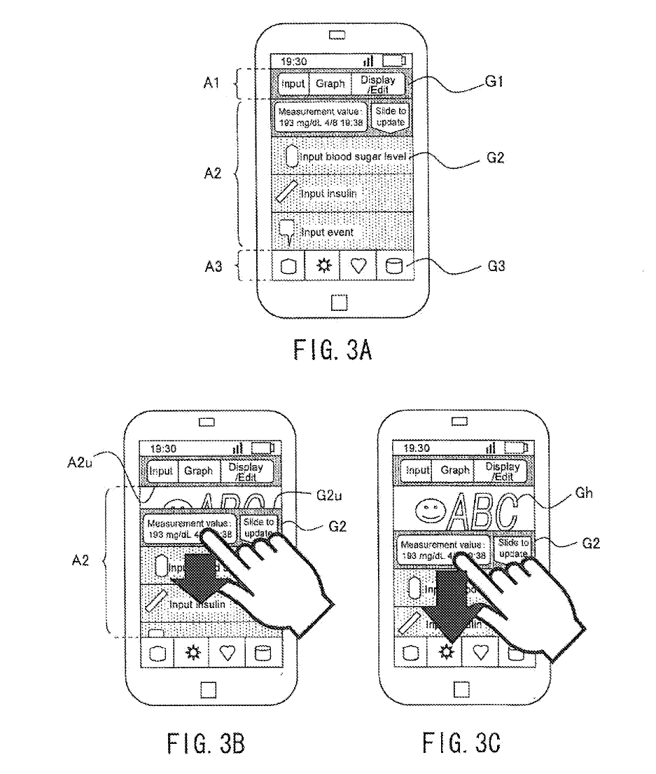

FIGS. 3A, 3B, and 3C are diagrams showing an example of a screen transition in the case where an image is displayed in a sliding manner. FIG. 3A shows an example of a screen that is displayed by the application executed by the control unit 2. In the example shown in FIG. 3A, the screen contains three display regions A1, A2, and A3, and images G1, G2, G3 are displayed in the respective regions. In this example, a sliding motion with respect to the image G2 is assigned to an operation for executing processing for updating information that is displayed in the image G2 to the latest information. For example, if the user touches a portion of the image G2 in the display region A2 with the user's finger and moves the finger toward the bottom of the screen while touching that portion with the finger, this motion is detected by the sliding motion detection unit 6 as a sliding motion with respect to the image G2.

If a sliding motion with respect to the image G2 is detected, the display control unit 8 displays the image G2 while sliding the image G2 within the display region A2 as shown in FIGS. 3B and 3C. The amount of sliding of the image G2 can be adjusted in accordance with the sliding motion. In this case, an upper edge G2u of the image G2 moves to the inside of an upper side A2u of the display region A2, and thus a space is formed between the upper edge G2u of the image G2 and the upper side A2u of the display region A2. An image Gh serving as the additional information is displayed in this space. It can also be said that the image Gh is prepared as an image constituting a back layer of the display region A2. In this example, the image Gh, which is the additional information, is displayed after the area of the space exceeds a certain size.

Also, if a sliding motion with respect to the image G2 is detected, separately from the above-described processing for sliding the image G2, processing for updating information that is indicated by the image G2 is also executed as processing of the application. In FIG. 3C, the information indicated by the image G2 is updated to the latest information. That is to say, the display control unit 8 displays the image G2 while sliding the image G2, the image G2 containing information that has been updated by the corresponding processing execution unit 7 as a result of the sliding motion with respect to the image G2.

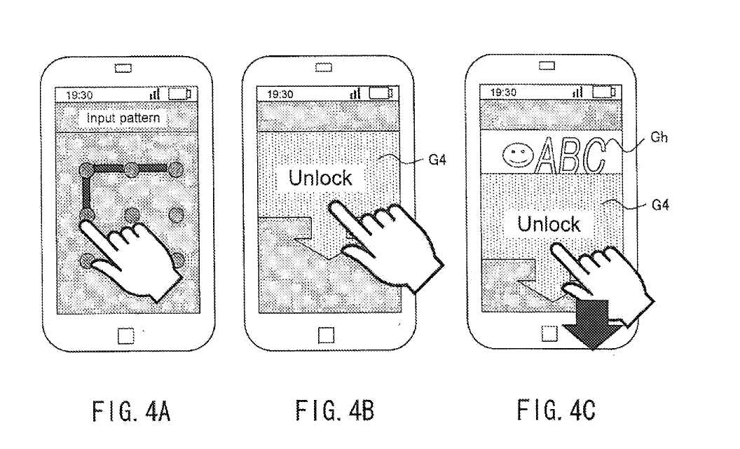

FIGS. 4A, 4B, and 4C are diagrams showing another example of a screen transition in the case where an image is displayed in a sliding manner. FIGS. 4A, 4B, and 4C show the example in the case where an operation for performing unlock processing is a sliding motion. When a pattern is input on an identification pattern input screen for unlocking shown in FIG. 4A, a sliding target image G4 as shown in FIG. 4B is displayed. In this example, the sliding target image G4 is an image that defines a region in which a sliding motion for unlocking is accepted. When the user moves the user's finger toward the bottom of the screen while touching the sliding target image G4 with the finger, the sliding motion detection unit 6 detects a sliding motion with respect to the sliding target image G4. On detecting this, the corresponding processing execution unit 7 performs the unlock processing, and the display control unit 8 executes display so as to slide the sliding target image G4 as shown in FIG. 4C. The image Gh, which is the additional information, is displayed in a space that is formed by the moving of the sliding target image G4.

Note that in the processing for sliding an image, the display control unit 8 can perform control such that sliding becomes more difficult as the amount of sliding that is performed by the user increases. For example, control can be performed such that the longer the moving distance from the start of the sliding motion, the shorter the distance for which the image is slid with respect to the moving distance of the finger per unit time. Thus, a movement having a sensation of elasticity can be realized. Moreover, control can also be performed such that when the finger is removed from the image, the image is slid in the opposite direction and returned to its original position (a flowchart example of this will be described later). Also in this case, control can be performed similarly such that the sliding is reversed with a springy, elastic movement.

In the above-described example, image display is controlled such that when the user overruns the slide screen in order to execute a necessary function of the application, an underlayer of the slide screen of the application, the underlayer usually being hidden, emerges, and the additional information is displayed on that underlayer. Therefore, the additional information is displayed as a result of the sliding operation that the user has performed to use the function of the application. Thus, the need to continuously display the additional information is eliminated, and the additional information is prevented from interfering with the user's use of the application. Also, since the additional information is displayed as a result of the operation for using the application, the additional information can be effectively presented to the user. For example, if the additional information is advertising information, even though the advertisement is displayed in a more modest manner without annoying the user than a display form in which the advertisement is continuously displayed in a portion of the screen, the advertisement can be displayed so as to be more impressive.

Also, the opportunity to present the additional information to the user is secured more easily by assigning processing that is performed frequently or that is of high importance, such as updating of the display information of a sliding target screen or unlocking of an application by the processing that is executed as a result of the sliding motion. Examples of such processing include, for example, processing that is inevitably performed in order to start using an application, processing for external communication, and the like.

As described above, additional information is displayed in a space that is formed by the sliding of an image, and thus the additional information, which is usually not displayed, can be displayed such that the user glimpses the additional information during the sliding operation. Moreover, the image is slid in accordance with the sliding motion of the user, and thus the user can carefully view the additional information by sliding the screen even further if the user is interested in the additional information. Furthermore, if the additional information is displayed for more than a certain duration, or if the area of the space that is formed by the sliding motion exceeds a certain size, another additional action such as opening a particular website can be executed (a flowchart example of this will be described later). For example, in the case where the additional information is to be displayed as an image, if an image is slid until the entire image of the additional information becomes visible, additional processing such as opening a particular website can be executed.

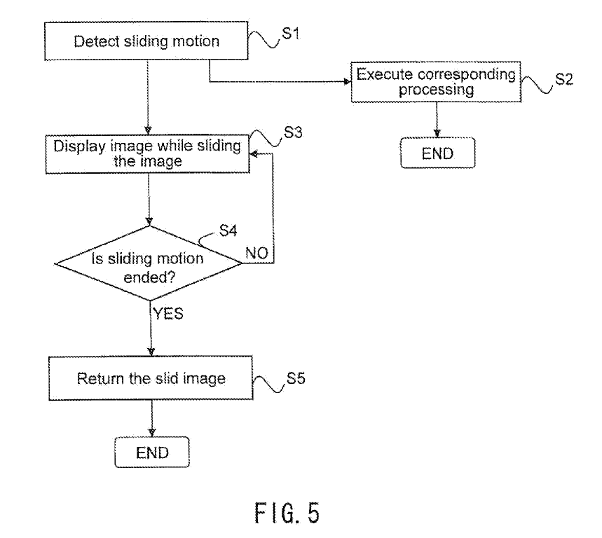

FIG. 5 is a flowchart illustrating an example of processing for performing control such that when the user ends a sliding motion and removes the user's finger from the image, the image is slid in the opposite direction and returned to its original position. In the example illustrated in FIG. 5, if a sliding motion of the user with respect to an image that is currently being displayed is detected (step S1), the corresponding processing execution unit 7 executes processing of an application corresponding to the sliding motion with respect to that image, and at the same time the display control unit 8 displays the image while sliding the image (step S3).

In step S3, even when displaying the image while sliding the image, the display control unit 8 can receive at regular intervals positions indicated by the user that are detected by the display panel 1 and update the position of the image to be slid in accordance with the positions indicated by the user. When it is detected that the user has removed the user's finger from the display screen, the display control unit 8 can judge that the sliding motion by the user is ended (YES in step S4). In this case, the display control unit 8 slides the image in a direction opposite to the direction in which the image is slid in step S3, thereby moving the image to the original position before sliding (step S5).

In step S5, the display control unit 8 can also perform control such that sliding of the image in the direction of the sliding motion is continued for a while after the user removes the user's finger from the screen, and then the image is slid in the opposite direction. In this case, the distance or duration for which the image continues to be slid in the same direction after the user removes the user's finger from the screen can be specified in accordance with the velocity of the sliding motion of the user. Thus, a natural movement can be realized as if the image slides due to inertia.

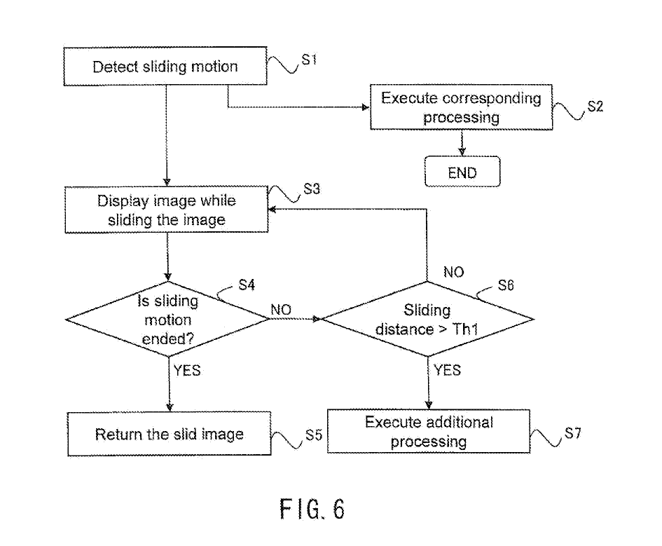

FIG. 6 is a flowchart illustrating an example of processing for executing additional processing if a sliding motion exceeds a certain amount of physical or temporal change. In the flowchart illustrated in FIG. 6, processing in steps S1 to S5 can be executed similarly to processing in those steps of FIG. 5. In the example in FIG. 6, if it is judged that the sliding motion of the user has not been ended (NO in step S4), the display control unit 8 judges whether or not the distance of the sliding motion that has been performed by the user exceeds a threshold value Th1 (step S6). For example, the distance of the sliding motion can be obtained by calculating the distance between the position of the finger at the start of sliding and the most recently acquired position of the finger. If it is judged that the distance of the sliding motion exceeds the threshold value Th1 (YES in step S6), the control unit 2 executes the additional processing (step S7).

The additional processing in step S7 is processing related to the additional information. For example, if the additional information is advertising information, processing for accessing a site on which information regarding the advertised product or service is published or processing for displaying detailed information regarding that product or service can be executed as the additional processing. With this configuration, if the user is interested in the additional information that the user glimpsed when performing a sliding motion with respect to an image, the user can receive information and service related to the additional information by simply continuing the sliding motion without removing the user's finger and it is not necessary to perform other particular operations. Note that in addition to the additional information, a message to the effect that additional processing is executed if the sliding motion is continued can be displayed in the space in which the additional information is displayed.

In the example illustrated in FIG. 6, additional processing is executed if the distance of a sliding motion of the user exceeds a threshold value; however, the control unit 2 may also be adapted to execute additional processing if the duration of the sliding motion exceeds a threshold value. For example, in step S6 of FIG. 6, the display control unit 8 can make a judgement using the duration of a sliding motion instead of the distance of the sliding motion. The duration of a sliding motion can be obtained by, for example, calculating the difference between the current time and the start time of the sliding motion, where the time point at which the user touches the display screen 4 with his/her finger is regarded as the start time of the sliding motion.

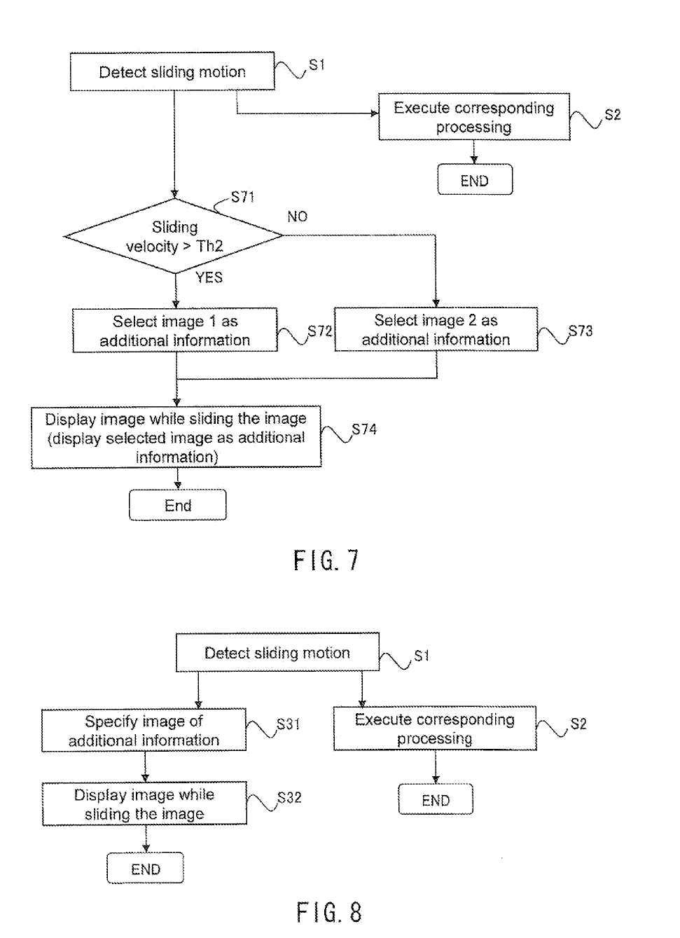

FIG. 7 is a flowchart illustrating an example of processing in which the control unit 2 controls, in accordance with the velocity of a sliding motion of the user, an image of the additional information to be displayed. In the example illustrated in FIG. 7, in step S1, the sliding motion detection unit 6 detects a sliding motion of the user and also acquires the velocity of the sliding motion at the same time. For example, if the control unit 2 receives at regular intervals the coordinates of positions that are indicated by the user from the display panel 1, a value calculated by dividing the distance between the coordinates of the start point of the sliding motion and the coordinates of the latest indicated position by the number of coordinate points that are received after the start of the sliding motion can be used as the velocity of the sliding motion.

The display control unit 8 judges whether or not the velocity of the sliding motion acquired in step Si exceeds a threshold value Th2 (step S71). If the velocity of the sliding motion exceeds the threshold value Th2 (YES in step S71), the display control unit 8 selects an image 1 as the image of the additional information (step S72), and if the velocity of the sliding motion does not exceed the threshold value Th2 (NO in step S71), the display control unit 8 selects an image 2 as the image of the additional information (step S73). The display control unit 8 displays the image of the additional information that is selected in step S72 or S73 in a space that is formed by the sliding of an image currently being displayed on the screen (step S74). In this manner, the image of the additional information is selected in accordance with the velocity of the sliding motion, and thus the additional information can be more effectively presented to the user.

Note that the control of the additional information that is performed in accordance with the velocity of the sliding motion is not limited to the image selection processing as in steps S72 and S73 described above. For example, it is also possible to change the size or the display position of the image of the additional information in accordance with the velocity of the sliding motion. For example, if the velocity of the sliding motion is faster than a threshold value, control can be performed such that the image of the additional information becomes larger than usual, and/or the image of the additional information is displayed in an upper position other than usual. Thus, even if the duration for which the image of the additional information is displayed is short, and the space is narrow, the image can be displayed such that the additional information is easily recognized. Moreover, in addition to the velocity of the sliding motion, the distance or duration of the sliding motion can also be used as a judgment factor for controlling the additional information.

FIG. 8 is a flowchart illustrating an example of an operation where the control unit 2 specifies an image to be displayed as the additional information out of a plurality of images and displays that image. In the example illustrated in FIG. 8, if a sliding motion is detected in step S1, the display control unit 8 executes processing for specifying the image of the additional information (step S31). In processing for displaying an image while sliding the image in step S32, the display control unit 8 displays the image of the additional information that is specified in step S31 in a space that is formed by the sliding of the image.

In step S31, the display control unit 8 can, for example, randomly select an image from images that are stored in the storage unit 3 in advance. This processing can be executed using, for example, random numbers. Thus, a plurality of images can be equally displayed as the additional information.

Moreover, the display control unit 8 can also select an image of the additional information from a plurality of images based on, for example, a predetermined probability. For example, it is possible to set probabilities for a plurality of images stored in the storage unit 3, respectively, and store the probabilities in association with the respective images in advance. In this case, the display control unit 8 can select an image such that the images are displayed with the respective probabilities associated therewith. For example, if the additional information is advertisements, and a plurality of advertising images are prepared, it is possible to assign probabilities corresponding to advertising rates to the respective images. Thus, the advertising information can be displayed with frequencies corresponding to the advertising rates.

Furthermore, if the additional information is, for example, advertisements, if there are, for example, ten sponsors of the additional information, and the ten sponsors pay different advertising rates (charges for displaying the additional information), the display control unit 8 can specify at least one of the display duration and the display order of the additional information to be displayed in the above-described space based on, for example, the previously stored charges for displaying the additional information. For example, for each of the plurality of advertisements (images) stored in the storage unit 3, at least one of the display duration and the display order of the additional information corresponding to that advertisement (image) can be stored in advance in association with that advertisement (image), based on the charge for displaying the additional information that is stored in the storage unit 3 in advance. In this case, the display control unit 8 can select an image such that each of the images is displayed with at least one of the display duration and the display order of the additional information, the display duration and the display order being associated with that image. Thus, it is possible to appropriately specify at least one of the display duration and the display order of the additional information (images) and display the additional information (images) in the space in accordance with the charges for displaying the additional information.

Note that although a case where the display control unit 8 specifies at least one of the display duration and the display order of the additional information to be displayed in the space based on the previously stored charges for displaying the additional information has been described in the foregoing description, the display control unit 8 of this embodiment is not limited to this case. Specifically, in the display control unit 8, a weighting factor for specifying at least one of the display duration and the display order of the additional information to be displayed in the space can be externally set as appropriate, and the display control unit 8 is configured to be able to specify at least one of the display duration and the display order of the additional information to be displayed in the space based on the weighting factor such as the preset charges for displaying the additional information and a particular client. That is to say, with respect to, for example, a particular client (e.g., favored client) that is preset as a weighting factor, the display control unit 8 can display the additional information regarding that client for a prolonged duration or preferentially display this additional information.

Moreover, the display control unit 8 can also specify an image of the additional information in accordance with, for example, an external device that is connected to the electronic device 10. If a connection between the electronic device 10 and an external device is detected, the control unit 2 stores data (e.g., flag or the like) indicating that the external device is connected to the electronic device 10. In step S31, if the display control unit 8 judges, based on this data, that the external device is connected, the display control unit 8 can read an image related to that external device from the storage unit 3 and display the read image as the image of the additional information. For example, the image related to the external device to be displayed as the additional information can be stored in advance or can be acquired by the control unit 2 from the external device as a result of the connection of the external device and stored in the storage unit 3.

By way of example, during execution of an application for blood sugar level measurement, information regarding a blood sugar level measuring device that is connected to the electronic device 10 can be displayed as the additional information. For example, an image of information indicating the manufacturer of the measuring device is displayed in a space that is formed by the sliding of an image, and thus the manufacturer of the measuring device can be advertised to the user modestly but effectively. Also, if a sliding motion of the user is set as a cue for processing for communicating with the measuring device or processing for controlling the measuring device, information regarding the measuring device can be brought to the user's notice at a timing at which processing in which the measuring device is concerned is executed. Thus, the user can indirectly check, for example, the connection status of the measuring device, and therefore an operation error and the like can be prevented. Moreover, the information on the measuring device is more likely to leave an impression on the user.

In the example illustrated in FIG. 8, an image of the additional information is specified each time a sliding motion is detected. However, instead of changing the additional information each time a sliding motion is detected, the image of the additional information may be changed only if a predetermined condition is met. Alternatively, it is also possible that if a predetermined condition is met, the image of the additional information is not changed, but rather the same image as the image that was displayed the previous time is displayed.

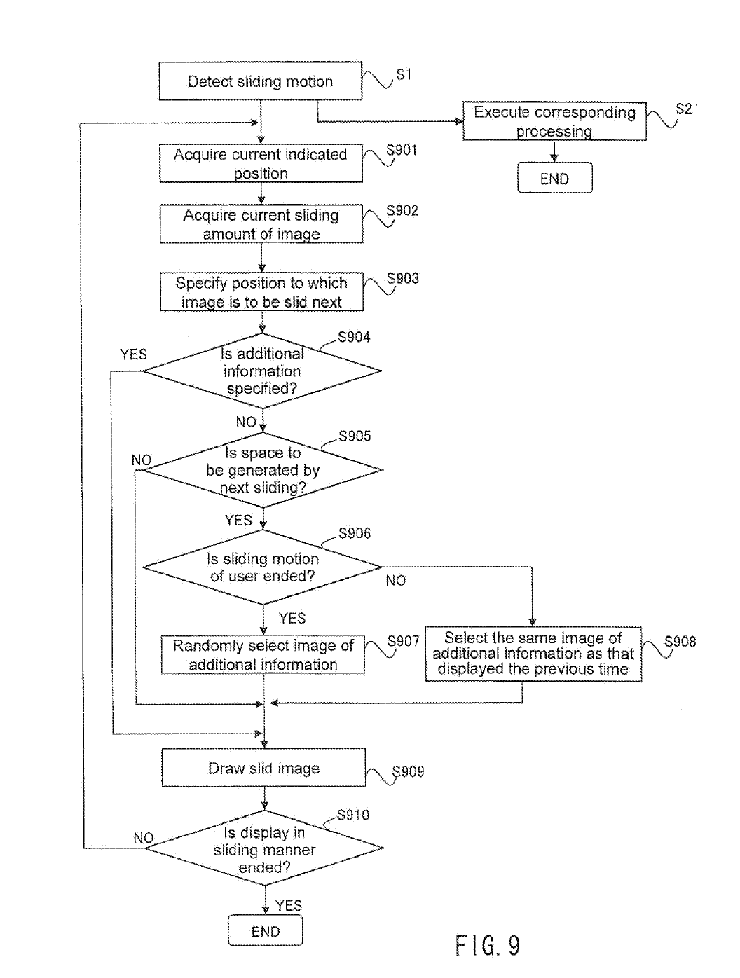

FIG. 9 is a flowchart illustrating an example of processing in which the control unit 2 controls the additional information based on a relationship between the timing at which the user performs a sliding motion and the timing at which a space is formed by the sliding of an image. In the example illustrated in FIG. 9, if a sliding motion of the user is detected in step S1, the display control unit 8 acquires the current indicated position that is indicated by the finger on the display screen (step S901) and the current amount of sliding of an image (step S902).

For example, the control unit 2 can obtain information on the latest indicated position by receiving signals indicating the indicated position from the display panel 1 at regular intervals. If the user has removed the user's finger from the display screen, and no position is indicated on the display screen, a configuration in which a signal indicating that effect is received from the display panel 1 or the signal stops can be adopted. Thus, the control unit 2 can detect the timings at which the user starts and ends a sliding motion and the path taken by the sliding motion.

The display control unit 8 specifies the amount for which the image is to be slid next time using the sliding motion of the user including the current indicated position acquired in step S901 and the current sliding amount of the image acquired in step S902 (step S903). For example, the display control unit 8 can specify the direction in which the image is to be slid based on the direction of the sliding motion of the user. Also, the display control unit 8 can specify the distance (sliding amount) for which the image is to be slid based on the velocity of the sliding motion, whether or not the user's finger has already been removed, or information on, for example, the time that has elapsed after the removal of the finger.

The display control unit 8 judges whether or not the image of the additional information has already been specified (step S904). If not (NO in step S904), the display control unit 8 judges whether or not a space is to be generated by the next sliding (step S905), and if a space is to be generated (YES in step S905), the display control unit 8 judges whether or not the sliding motion of the user has ended (step S906). If the sliding motion has ended (YES in step S906), an image that is randomly selected from a plurality of images is used as the image of the additional information (step S907). If the sliding motion has not yet ended (NO in step S906), the same image as the image of the additional information that was displayed the previous time is selected (step S908). Note that “the image of the additional information that was displayed the previous time” as used herein refers to an image that was displayed at the closest time point of the additional information that was displayed not by a sliding motion currently being detected, but by a sliding motion prior to that sliding motion.

The above-described judgment processing in steps S905 and S906 makes it possible to determine whether or not the sliding motion of the user has already ended when a space is generated by the sliding of an image. This judgment processing is an example of processing for determining the relationship between the timing of a sliding motion and the timing at which a space is formed by displaying an image while sliding the image.

The display control unit 8 causes the image to be slid to a sliding position specified in step S903 and displayed (step S909). At this time, if a space is formed by the sliding of the image, the image selected in step S907 or S908 is displayed in that space. After that, processing for specifying a position to which the image is to be slid based on the indicated position indicated by the user and the sliding amount of the image (step S903) and drawing the image (step S909) is repeated. The processing is repeated until it is judged that sliding of the image is ended (YES in step S910). For example, if an image is slid and then returned to the original position by being slid in the opposite direction, it is possible to judge that sliding of the image is ended. To take a specific example, if the sliding motion of the user has ended, and the sliding amount of the image is zero, it is possible to judge YES in step S910.

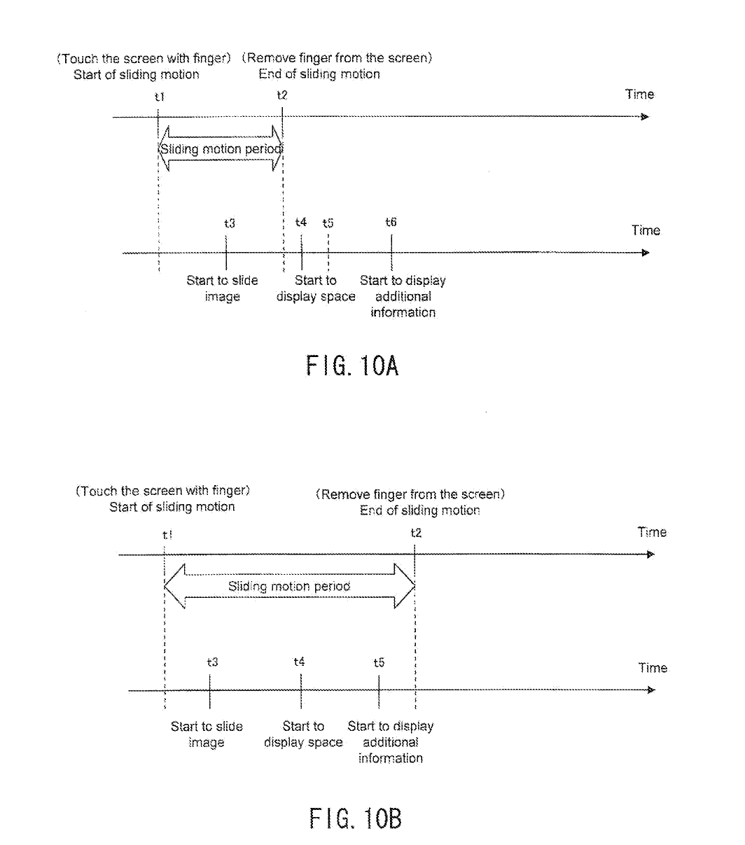

FIG. 10A is a diagram for illustrating an example in the case where the sliding motion of the user has ended at the time when a space is generated (YES in step S905 and YES in step S906 of FIG. 9). FIG. 10B is a diagram for explaining an example in which the sliding motion of the user has not yet ended when a space is generated (YES in step S905 and NO in step S906 of FIG. 9). As shown in FIGS. 10A and 10B, a time period from when the user's finger touches the display screen at time t1 and slides on the display screen to when the finger is removed from the display screen at time t2, that is, the time period from time t1 to time t2 is regarded as the sliding motion period.

In the example in FIG. 10A, sliding of the image is started at time t3 during the sliding motion period, and after the sliding motion of the user is ended, a space is formed at time t4 due to the sliding of the image, and an image of the additional information is displayed in that space at time t6. This may occur in, for example, a case when the user swiftly slides the user's finger on the image on the display screen and removes the finger from the display screen immediately while sliding of the image continues even after the removal of the finger, and the image is thus scrolled within the display region, and even after the edge of the image reaches the side of the display region, the momentum of the image causes the edge of the image to move to the inside of the display region, thereby forming a space. In this case, the sliding motion of the user is not intended to form a space or to view the additional information.

By contrast, in the example in FIG. 10B, a space is formed at time t4 during the sliding motion period due to the sliding of the image, and after that, the user does not remove the user's finger from the display screen and still continues the sliding motion. This sliding motion of the user is highly likely to be intended to form a space and view the additional information to be displayed in that space. Accordingly, it is possible to estimate whether the user intended to view the additional information by discriminating between the case of FIG. 10A and the case of FIG. 10B by judging whether or not the sliding motion of the user has ended when a space is generated. Also, controlling the additional information based on this judgement makes it possible to display the additional information that is highly likely to conform to the user's intention. Note that in steps S905 and S906 of FIG. 9, whether or not a sliding motion has ended is judged at the time when a space starts to be displayed, that is, at time t4, but it is also possible that whether or not a sliding motion has ended is judged at a time point (time t5) that is after the start of the display of a space (time t4) and that is prior to time t6 at which the display of the additional information is started.

In the example shown in FIG. 9, if the sliding motion is continued when a space is formed (in the case of FIG. 10B), the same image as that of the additional information that was displayed due to a previous sliding motion is displayed. Thus, in the case in which it is highly likely that the user performed the sliding motion with intent to view again the additional information that was displayed the previous time, the additional information that was displayed the previous time can be displayed again. In this manner, it is possible to estimate the user's intention by distinguishing a subtle difference in the sliding motion of the user by determining the relationship between the timing of the sliding motion and the timing at which a space is formed by displaying an image while sliding the image, and allow the estimated user's intention to be reflected in the control of the additional information. For example, it is possible to provide the additional information appropriately with respect to the degree of the user's interest in the additional information by controlling the additional information based on the judgment of whether or not the sliding motion of the user has ended when a space is generated.

Note that the control of the additional information based on the determination result regarding the timings of the sliding motion and the display of a space is not limited to the examples illustrated in steps S907 and S908 of FIG. 9. For example, in addition to the configuration in which an image of the additional information is selected, the size and/or the display position etc. of the image may also be controlled based on the above-described judgment result. Moreover, the brevity and the specificity of the additional information can also be changed in accordance with the above-described judgment result.

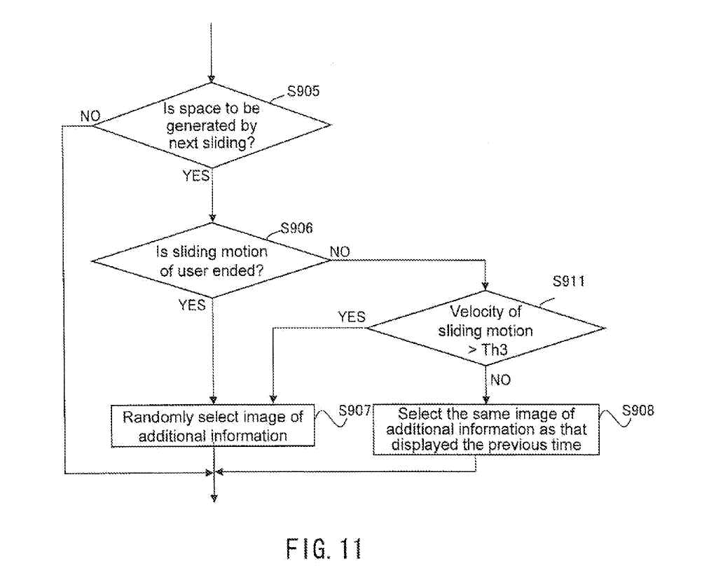

FIG. 11 is a flowchart illustrating a variation of the judgment processing in steps S905 and S906 of FIG. 9. In the example illustrated in FIG. 11, the display control unit 8 makes judgment using the velocity of the sliding motion in addition to the relationship between the timing of the sliding motion and the timing of the display of a space. Specifically, when a space is formed by displaying an image while sliding the image (YES in step S905), if the sliding motion of the user has not yet been ended (NO in step S906), the display control unit 8 judges whether or not the velocity of the sliding motion is greater than a threshold value Th3 (step S911). If the velocity of the sliding motion exceeds the threshold value Th3 (YES in step S911), it is presumed that the user does not intend to view the additional information, and therefore an image of the additional information is selected randomly (step S907). On the other hand, if the judgment result is NO in step S911, it is presumed that the user intends to view the additional information, and therefore the display control unit 8 selects the same image as that of the additional information that was displayed the previous time (step S908). In this manner, it is possible to display the additional information so as to even further conform to the user's intention by controlling the image of the additional information to be displayed in the space based on not only the relationship between the timing of the sliding motion of the user and the timing at which the space is formed by displaying an image while sliding the image in accordance with that sliding motion but also the velocity of that sliding motion.

Although an embodiment of the present disclosure has been described above, the scope of the present disclosure is not limited to the above-described embodiment. It is also possible to combine the plurality of operation examples described above as appropriate. For example, the processing for specifying the image of the additional information (step S31) in FIG. 8 may also be combined with the processing for selecting an image based on judgment of the velocity of the sliding motion in FIG. 7. Moreover, the above-described image selection processing in steps S72 and S73 of FIG. 7 may also be replaced by steps S907 and S908 of FIG. 9.

Also, the indicated position detecting method of the display panel is not limited to any particular method. For example, a touch panel using a resistive technology, a capacitive technology, a photosensor technology, a surface acoustic wave technology, an acoustic pulse recognition technology, an infrared technology, a strain gauge technology, or a dispersive signal technology or other technologies can be used.

Moreover, in the processing for selecting the additional information, the additional information to be selected is not limited to an image, and, for example, text data, link data, or the like can also be selected as the additional information.

Furthermore, in addition to the foregoing description, it is possible to install an application for, for example, managing data of a patient on the electronic device 10. Specifically, it is possible to cause a smartphone serving as the electronic device 10 to execute an application for, for example, allowing recording, browsing, and so on of various types of data on a diabetic such as blood sugar levels, the times at which blood samples for measuring those blood sugar levels were taken, and the like. In this case, a portion of the screen of the smartphone can be used as an advertisement display space, and some advertisements can be continuously displayed. Moreover, in the case where there is a plurality of companies that pay advertising rates, the duration and the order in which the advertisements are displayed can also be varied in accordance with the difference in advertising rate (above-described weighting factor). Furthermore, in addition to the advertising rate, the duration and the order in which the advertisements are displayed can also be varied with respect to, for example, a particular client (e.g., favored client) that is set as the above-described weighting factor.

What is claimed is:

1. An electronic device comprising:
a display panel having a display screen and a detection unit that detects a position on the display screen of a finger or a pointing tool; and
a control unit that executes software for realizing a particular function involving an output of an image to the display panel,
wherein on detecting a sliding motion of a user's finger or a pointing tool on the display panel on which the image is displayed, the control unit executes processing that is necessary in order to realize the function of the software, and in accordance with the sliding motion of the finger or the pointing tool, displays the image while sliding the image and furthermore displays additional information in a space that is formed by the sliding of the image.

2. The electronic device according to claim 1, wherein if an amount of physical or temporal change in the sliding motion of the finger or the pointing tool exceeds a threshold value, the control unit further executes additional processing.

3. The electronic device according to claim 1, wherein the control unit executes locking or unlocking of the electronic device, updating of the screen, or external data communication of the electronic device as the processing that is necessary in order to realize the function of the software.

4. The electronic device according to claim 1, wherein the control unit controls the additional information to be displayed in the space in accordance with a velocity of the sliding motion of the finger or the pointing tool.

5. The electronic device according to claim 1, wherein the control unit determines a relationship between a timing of the sliding motion of the finger or the pointing tool and a timing at which the space is formed by displaying the image while sliding the image in accordance with the sliding motion, and controls the additional information to be displayed in the space based on the determination.

6. The electronic device according to claim 1, wherein the control unit randomly selects the additional information to be displayed in the space from a plurality of items of previously stored information.

7. The electronic device according to claim 1, wherein the control unit selects the additional information to be displayed in the space from a plurality of items of previously stored information based on a previously stored probability.

8. The electronic device according to claim 1, wherein the control unit specifies, based on a previously stored charge for displaying the additional information, at least one of a display duration and a display order of the additional information to be displayed in the space.

9. The electronic device according to claim 1, wherein the control unit specifies the additional information to be displayed in the space in accordance with an external device that is connected to the electronic device.

10. The electronic device according to claim 5,
wherein the control unit specifies the additional information to be displayed in the space each time the space is formed, and
at a time point when the space is formed or at any time point during a period from said time point to when the additional information is displayed in the space, the control unit determines whether or not the sliding motion of the finger or the pointing tool has already ended, and if the sliding motion has not yet ended, the control unit displays information that is the same as the additional information displayed the previous time in the space.

11. A method for controlling an electronic device including a display panel having a display screen and a detection unit that detects a position on the display screen of a finger or a pointing tool, the method comprising:
a step of a computer provided in the electronic device executing software for realizing a particular function involving an output of an image to the display panel;
a step of the computer executing processing that is necessary to realize the function of the software on detection of a sliding motion of a user's finger or a pointing tool on the display panel on which the image is displayed;
a step of displaying the image while sliding the image in accordance with the detected sliding motion of the finger or the pointing tool; and
a step of displaying additional information in a space that is formed by the sliding of the image.

12. A program for controlling an electronic device including a display panel having a display screen and a detection unit that detects a position on the display screen that is designated with a finger or a pointing tool, the program causing a computer to execute the steps comprising:
processing for executing software for realizing a particular function involving an output of an image to the display panel;
processing for executing processing that is necessary to realize the function of the software on detection of a sliding motion of a user's finger or a pointing tool on the display panel on which the image is displayed;
processing for displaying the image while sliding the image in accordance with the detected sliding motion of the finger or the pointing tool; and
processing for displaying additional information in a space that is formed by the sliding of the image.

13. An electronic device comprising:
a display panel having a display screen and a detection unit that detects a position on the display screen of a finger or a pointing tool; and
at least one processor, a memory, and at least one program,
wherein the program is configured to be stored in the memory and executed by the at least one processor, the program including:
an instruction for executing software for realizing a particular function involving an output of an image to the display panel;
an instruction for detecting a sliding motion of a user's finger or a pointing tool on the display panel on which the image is displayed;
an instruction for executing processing that is necessary to realize the function of the software on detection of the sliding motion;
an instruction for displaying the image while sliding the image in accordance with the sliding motion of the finger or the pointing tool; and
an instruction for displaying additional information in a space that is formed by the sliding of the image.
